(19) United States
(12) Patent Application Publication
(10) Pub. No.: US 2008/0082434 A1
(43) Pub. Date: Apr. 3, 2008

(54) System and Method for Making Payment

(75) Inventors: Zhilong Qian, Hangzhou (CN); Li Wang, Hangzhou (CN)

Correspondence Address: LEE & HAYES, PLLC, 421 W. RIVERSIDE AVE, STE 500, SPOKANE, WA, 99201, US

(73) Assignee: ALIBABA.COM CORPORATION, Grand Cayman (KY)

(21) Appl. No.: 11/864,676

(22) Filed: Sep. 28, 2007

(30) Foreign Application Priority Data
Sep. 29, 2006 (CN) 200610140664.3

(51) Int. Cl. G06Q 40/00

(52) U.S. Cl. 705/34; 705/40

(57) ABSTRACT

A payment system includes a central account registration system to bind multiple payment platforms into an account federation to accomplish convenient and secure cross-platform payment. The central account registration system assigns a federation user ID to each federation user and stores mapping information between the user's federation user ID and the user's account in its payment platform. Upon receiving an operation request of a first user from a first payment platform, the central account registration system provides the account information of a second payment platform to the first payment platform according to a federation user ID of a second user. Payment system is then able to make a cross-platform payment between the first payment platform and the second payment platform based on the account information provided by the central account registration system. A method of making payment using the payment system is also disclosed.

### RELATED APPLICATIONS

This application claims benefit of an earlier filing date of Chinese patent application, Application No. 200610140664.3, filed on Sep. 29, 2006, entitled “METHOD AND SYSTEM FOR MAKING PAYMENT”.

### TECHNICAL FIELD

This disclosure relates to the fields of computer technologies and network technologies, and in particular to methods and systems used in electronic commerce, such as a method and a system of making a payment.

### BACKGROUND

In electronic commerce, it is desirable have a network to allow deposits, withdrawals and payments to be made anywhere with little or none cross-bank or cross-institution barriers. Various systems have been set up to provide such nationwide or even global conveniences. In China, for example, the banks achieve “deposit and withdrawal anywhere” through China FederationPay for buyers pay sellers who are not members of the same bank. Under normal conditions of such systems, the banks do not provide any guarantee for cash on delivery (COD). If a payment needs to be made safely between users, it requires a third-party payment platform that provides a safe payment function to complete a transaction.

FIG. 1 shows a block representation of an exemplary existing payment system. In FIG. 1, both payment platform 1 and payment platform 2 are third-party platforms providing services to the users. Since there is no network communication between payment platform 1 and payment platform 2, there is no guarantee for any kind of security when a transaction is made between users in different payment platforms. For instance, the users A1 and B1 in the same payment platform 1 (which provides security service within the platform itself) can directly conduct a safe transaction. Likewise, users A2 and B2 in the payment platform 2 (which also provides security service within the platform itself) can conduct a safe transaction with each other. However, a user in payment platform 1 and a user in payment platform 2, for example, user A1 and user A2, cannot conduct a transaction with security.

Because the existing payment systems are unable to provide security for transactions across different payment platforms, e-commerce users often suffer much inconvenience and lack of security.

### SUMMARY

The present disclosure describes a payment system that includes a central account registration system to bind multiple payment platforms into an account federation to accomplish convenient and secure cross-platform payment. Each user is both a member of a payment platform (payment platform user) and a member of the federation (federation user). The central account registration system assigns a federation user ID to each federation user and stores mapping information between the user's federation user ID and the user's account in its payment platform. Upon receiving an operation request of a first user from a first payment platform, the central account registration system provides the account information of a second payment platform to the first payment platform according to the federation user ID of a second user who is a member of the second payment platform. Payment system is then able to make a cross-platform payment between the first payment platform and the second payment platform based on the account information provided by the central account registration system. A method of making payment using the payment system is also disclosed.

The payment may be initiated by either a seller or a buyer. Various protocols may be implemented to accomplish secure and controlled payments.

With the present payment system and method, a payment platform can use a federation user ID to directly parse the account system of another platform, thus providing security to transactions between users across different payment platforms.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows a block representation of an exemplary existing payment system.

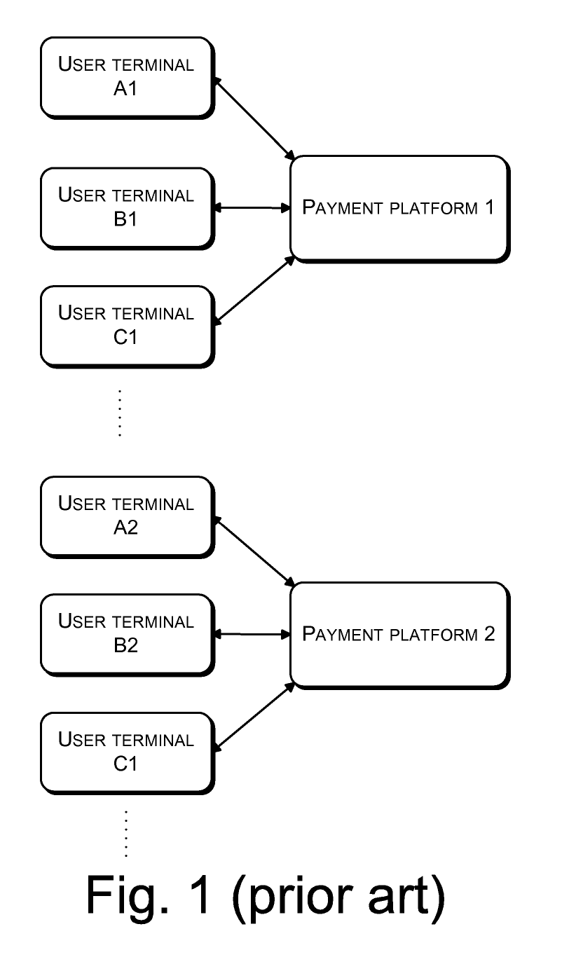

FIG. 2 shows a block diagram illustrating a payment system in accordance with the present invention.

FIG. 3 shows a flowchart of an exemplary payment process in which the payer (buyer) initiates the payment process.

FIG. 4 shows a flowchart of an exemplary payment process in which the payee (seller) initiates the payment process.

FIG. 5 shows an exemplary environment for implementing the payment system.

### DETAILED DESCRIPTION

Overview

The present description discloses a system and a method of making payment for users to make safe payments across different payment platforms.

One aspect of the disclosure is a payment system implemented with a computing device having one or more processors and one or more I/O devices. The payment system includes a central account registration system adopted for connecting multiple payment platforms to form an account federation in which each user has at least one federation user account and at least one platform user account. The platform user account is a user account a user holds with a certain payment platform. Each federation user account is associated with a federation user ID. The federation user IDs are assigned by the central account registration system.

Each user may have multiple federation user account, but preferably federation user accounts should be non-redundant with each federation user account corresponding to a unique federation user ID. Each federation user account may be mapped, separately, to multiple platform user accounts, but preferably one federation account may be mapped to no more than one platform user account for any given payment platform.

In one embodiment, the central account registration system includes a computer readable media having stored thereupon account information and account mapping data defining account mapping relationships between the federation user accounts and the platform user accounts. Upon receiving from a first platform an operation request of a first user, the central account registration system provides account information of a second payment platform to the first payment platform according to a second user's federation user ID included with the operation request of the first user. The payment system makes a payment according to the account information of the second payment platform that has been resolved.

The account information of a payment platform provided by the central account registration system to another payment platform can be any information that may be useful to facilitate the subsequent payment procedure. For example, the account information of the second payment platform provided to the first payment platform may include information of a system account of the second payment platform, and/or information of a platform user account of the second user in the second payment platform corresponding to the second user's federation user ID. If the first payment platform only needs to contact a system account of the second payment platform, the information of the second user's platform user account in the second payment platform may not be needed. Likewise, if the first payment platform only needs to contact the second user's platform user account in the second payment platform, the information of the system account of the second payment platform may not be needed. In either case, it is preferred that the second user's federation user ID and its corresponding platform user ID or platform account information in the second payment platform be made available, such that an item (such as a payment deposit) sent by the first payment platform to the second payment platform may be properly identified and associated with the correct user (the second user in this example).

All payment platforms that can transfer funds are joined together into one federation to enable fund transfer from one platform to another. Each user account in a platform is mapped to a federation user account in the central account registration system. When inter-platform transaction occurs, the platform that initiates the transaction inquires, through the central account registration system, about the information of another user's payment platform and the information of that user's platform user account according to the same user's federation user account.

The central account registration system may create a user profile for each user. Each user profile can have one or more federation user accounts which are collectively identified and managed under the same user profile. The federation user accounts under the same user profile may represent the accounts held by the user in the different payment platforms. Alternatively, the central account registration system may create no user profile for users. In that case, the central account registration system simply stores the mapping information between the federation user accounts and their corresponding platform user accounts. On the other hand, a federation user account may be allowed to belong to more than one federation user profiles, provided that there is valid authorization by all the related users.

In one embodiment, the central account registration system may require that all mapped accounts be associated with a respective user profile. In this case, when a user registers in its payment platform, it may be desirable that the payment platform request the user provide previously owned federation user profile identification so that the user can obtain a federation user account to be mapped with the platform user account registered at the same time. If the user cannot provide this identification, the system may first create a federation user profile for the user and then request a federation user account for the user to be mapped with the registered platform user account. The new federation user account will then be associated with the newly created federation user profile.

The user information with the federation user profile can be any required information. In one embodiment, the mapping relationship between a federation user account and its platform user account is unique for any given payment platform. For a particular payment platform, there may be none platform user account mapped with a federation user account (indicating that the user is not related to the particular payment platform). However, when there is a corresponding platform user account in the particular payment platform, it may be preferred that there is no more than one such platform user account in the given payment platform mapped to the federation user account. It may also be preferred that a federation user account has a unique federation user ID in the entire federation to ensure effectiveness and uniqueness in identifying a platform user account in the federation using a federation user ID.

Another aspect of the present disclosure is a payment system which has multiple payment platforms including a first platform and a second platform, and a central account registration system connecting the payment platforms to form an account federation. The central account registration system stores account mapping information between a federation user account and a platform user account, and assigns a federation user ID to each federation user account. Upon receiving from the first payment platform an operation request of a first user, the central account registration system provides account information of the second payment platform to the first payment platform according to a second user's federation user ID included with the operation request of the first user. The payment system then makes a payment according to the provided account information of the second payment platform. The first payment platform may verify the identity of the first user after receiving the operation request from the first user.

In the payment system, the first payment platform is adapted for performing one or more of the following:

(1) receiving the information of the second payment platform from the central account registration system;

(2) transferring the payment from an account of the first user to a system account of the first payment platform, the account of the first user being either a platform user account or a separate user account; and

(3) transferring the payment from the system account of the first payment platform to a system account of the second payment platform.

In one embodiment, the above step of transferring the payment from the account of the first user to the system account of the first payment platform may be performed only if the current business is of a delayed clearance type; and the step of transferring the payment from the system account of the first payment platform to the system account of the second payment platform may be performed only if terms of transaction have been met.

The second payment platform is adapted for transferring the payment from a system account of the second payment platform to an account of the second user. The account of the second user may be either a platform user account or a separate user account that is not built in a payment platform directly involved in the present transaction, but rather in a separate system which is able to communicate with at least one of the payment platforms involved in the present transaction.

The second payment platform may notify the second user the receipt of the first user's payment after the payment has been transferred into an account of the second user.

In one embodiment, the first payment platform transfers the payment from a system account of the first payment platform back to an account of the first user if the first user and the second user are unable to conclude the transaction.

Another aspect of the present disclosure is a payment system that has multiple payment platforms including a first platform and a second platform, and a central account registration system connecting the payment platforms to form an account federation. The central account registration system assigns a federation user ID to each federation user account, and stores account mapping information between a federation user account and a platform user account. Upon receiving from the second payment platform an operation request by a second user containing a first user's federation user ID, the central account registration system provides account information of the first payment platform to the second payment platform according to the first user's federation user ID. The second payment platform then instructs the first platform to set up a payment collection item according to the provided account information of the first payment platform. The first payment platform sets up the payment collection item, receives a payment from an account of the first user into the payment collection item, and transfers the payment from the payment collection item to the second payment platform.

In the above embodiment, the first payment platform may be adapted for transferring the payment from the payment collection item to the second payment platform upon receiving a payment clearance permission from the first user. The second payment platform then transfers the received payment into an account of the second user. After the payment has been transferred into an account of the second user, the second payment platform notifies the second user that the payment has been cleared.

Barring a clearance permission, the first payment platform may transfer the payment from the payment collection item back to the account of the first user upon receiving a payment revocation request from the first user and/or a cancellation authorization from both the first payment platform and the second payment platform.

Yet another aspect of the present disclosure is a method of making payment using in a payment system as described above. The method of making payment includes the following:

(a) receiving from a first payment platform an operation request of a first user, the operation request containing a second user's federation user ID;

(b) providing account information of a second payment platform to the first payment platform according to the second user's federation ID included with the operation request; and

(c) making a payment according to the account information of the second payment platform.

In one embodiment, when the current business is of a delayed clearance type, the above step (c) is completed only after terms of transaction have been satisfied.

The above step (a) may include the following sub-steps:

(a1) receiving the operation request at the first payment platform from the first user; and

(a2) receiving the operation request at the central account registration system from the first payment platform.

In one embodiment, the operation request further contains information of the first user's ID. The first payment platform verifies the first user's ID before performing the above step (a2).

In one scenario, the operation request of the first user is for making a payment to the second user, and the step (c) includes the following sub-steps:

(c1) transferring the payment from an account of the first user to a system account of the first payment platform, the account of the first user being either a platform user account or a separate user account;

(c2) transferring the payment from the system account of the first payment platform to a system account of the second payment platform according to the account information of the second payment platform provided to the first payment platform; and

(c3) transferring the payment from the system account of the second payment platform to an account of the second user, the account of the second user being either a platform user account or a separate user account.

In one embodiment, the above step (c) includes the following sub-steps:

(c1) transferring the payment from an account of the first user to a system account of the first payment platform, the account of the first user being either a platform user account or a separate user account; and

(c2) transferring the payment from the system account of the first payment platform back into the account of the first user if the first user and the second user are unable to conclude the transaction.

Alternatively, when the operation request by the first user is to receive a payment from the second user, the step (c) may include the following sub-steps:

(c1) setting up a payment collection item at the second payment platform;

(c2) transferring a payment from the second user into a system account of the second payment platform according to the payment collection item; and

(c3) transferring the payment from the system account of the second payment platform to the first user if terms of transaction are satisfied, or transferring the payment from the system account of the second payment platform back to the second user if the terms of transaction are unsatisfied.

Yet another aspect of the present disclosure is a method of making payment using the payment system as described herein. The method of making payment includes:

(a) receiving from a second payment platform an operation request of a second user, the operation request containing a first user's federation user ID;

(b) providing account information of the first payment platform to the second payment platform according to the first user's federation ID provided with the operation request; and

(c) making a payment from the first user to the second user according to the account information of the first payment platform provided to the second payment platform.

The above step (c) may include the following sub-steps:

(c1) setting up a payment collection item at the first payment platform;

(c2) transferring a payment from the first user into a system account of the first payment platform according to the payment collection item; and

(c3) transferring the payment from the system account of the first payment platform to the second user if terms of transaction are satisfied, or transferring the payment from the system account of the first payment platform back to the first user if the terms of transaction are unsatisfied.

### EXEMPLARY EMBODIMENTS

The following description generally assumes that the first user is a payer (buyer) and the second user is the payee (seller), and the first user is associated with the first payment platform, while second user is associated with the second payment platform. The order in which the method is described is not intended to be construed as a limitation, and any number of the described blocks may be combined in any order to implement the system or method, or an alternate system or method.

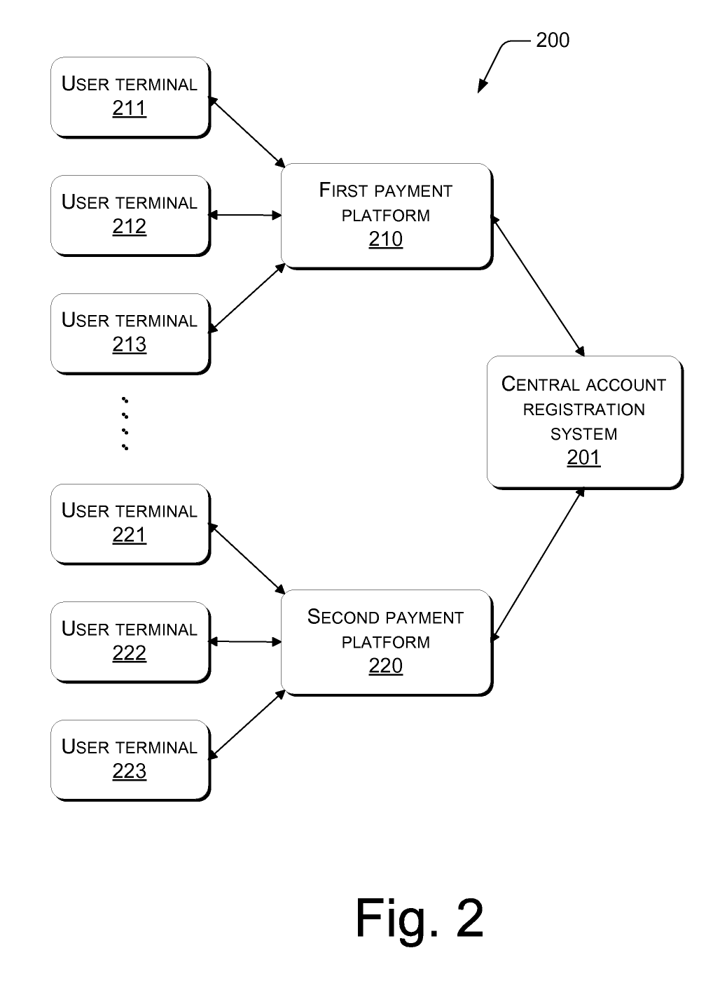

FIG. 2 shows a block diagram illustrating a payment system in accordance with the present invention. With reference to FIG. 2, payment system 200 has central account registration system 201 and first payment platform 210 and second payment platform 220. Multiple user terminals 211, 212 and 213 are connected with first payment platform 210, and likewise multiple user terminals 221, 222 and 223 are connected with second payment platform 220. Each user terminal may represent a user of the payment system 200. Unless otherwise distinguished, the terms “user” and “user terminal” may be used interchangeably in this description.

For simplicity, FIG. 2 only shows two payment platforms 210 and 220. It is appreciated that the payment system 200 may include any number of payment platforms. The central account registration system 201 connects with the first and the second payment platforms 210 and 220 which in turn each connects with multiple user terminals.

The central account registration system 201 binds all the accounts in many payment platforms to form a platform federation or a platform account federation. Each user is both a member of a payment platform (payment platform user) and a member of the federation (federation user). The central account registration system 201 assigns each federation user a federation user ID and sets up mapping relationships including correspondences between a user's federation user ID and the user's platform user account (an account in a payment platform). The payment platform (210 or 220) use a user's federation user ID to inquire about the information of the user's platform user account through the central account registration system 201.

In addition, the central account registration system 201 stores the mapping information between the federation user IDs and platform user accounts in payment platforms 210 and 220.

Each user may have multiple federation user account, but preferably federation user accounts should be non-redundant with each federation user account corresponding to a unique federation user ID. Each federation user account may be mapped, separately, to multiple platform user accounts, but preferably one federation account may be mapped to no more than one platform user account for any given payment platform.

Users conduct cross-platform payment transactions using the payment system 201. For example, the first user 211 may be in contact with the second user 221 and the two users may have established a business relationship. The first user 211 may have acquired the federation user ID of the second user 221 in the process, and may use the information to initiate a payment process. To do this, the first payment platform 210 sends an operation request by the first user 211 to the central account registration system 201. The operation request in this example is a request for making a payment. The operation request includes the federation user ID of the second user 221. When the central account registration system 201 receives this request, it sends the account information of the second payment platform 220 according to the federation user ID of the second user 221. Such account information may include the information of a system account of the second payment platform 220 and/or the information of a platform user account of the second user 221 in the second payment platform 220. After receiving this account information, the first payment platform 210 may proceed to complete the payment process.

For example, if the current business is of a delayed-clearance type, the first payment platform 210 transfers a payment fund from an account of the first user 211 to the first payment platform 210. This could take place in variety of ways. The account of the first user 211 having the initial payment found may either be a platform user account of the first user 211 set up in the first payment platform 210 or a separate user account that is not built in the first payment platform 210. The payment fund may be transferred into a system account (such as a temporary holding account for multiple users) in the first payment platform 210, or into a platform user account of the first user 211 in the first payment platform 210. The following exemplary description assumes that the payment fund is transferred from a user account of the first user 211 into a system account of the first payment platform 210.

After the first user 211 and the second user 221 have agreed on the terms of the transaction, the first payment platform 210 can then transfer the payment into a system account of the second payment platform 220, which subsequently transfers the payment into a platform user account of the second user 221 in the second payment platform 220. After that, the second payment platform 220 may notify the second user 221 the receipt of the payment of the first user 211. However, if the users cannot conclude the transaction due to an unsatisfied condition or term, the first payment platform 210 may transfer the fund from its system account back into the account of the first user 211 before it transfers the fund to the system account of the second payment platform 220.

In another illustrative scenario, the second payment platform 220 may initiate the payment process by sending an operation request by the second user 221 to the central account registration system. The operation request in this scenario is a request that a payment to be made by the first user 211. The operation request includes the information of the federation user ID of the first user 211. Upon receiving this operation request, the central account registration system 201 sends the account information of the first payment platform 210 according to the first user's federation user ID. Such account information may include the information of a system account of the first payment platform 210 and/or the information of a platform user account of the first user 211 in the first payment platform 210.

After receiving the necessary information of the first payment platform 210, the second payment platform 220 instructs the first payment platform 210 to set up a payment collection item. The first payment platform 210 creates a payment collection item according to the instruction and notifies the first user 211 that a payment needs to be made. The first user 211 may respond by submitting a payment request to the first payment platform 210. After receiving the payment request from the first user 211, the first payment platform 210 transfers the payment from the account of the first user into the payment collection item and informs the second payment platform 220 the receipt of the payment. In case where the current business is of a delayed-clearance type, the payment process may hold until a certain transaction condition has been met. For example, the first payment platform 210 may hold the payment before transfers it to the second payment platform until the first and the second users have agreed on the terms of the transaction.

Upon receiving the payment transfer from the first payment platform 210, the second payment platform 220 may then transfer the payment to the account of the second user 221. After transferring the received payment into the account of the second user 221, the second payment platform 220 notifies the second user 221 that the payment has been cleared.

However, if the first payment platform 210 receives a request for revoking the payment, the first payment platform 210 may transfer the payment fund from the payment collection item back into the account of the first user. This reversal operation may require authorization of both the first user 211 and the second user 221.

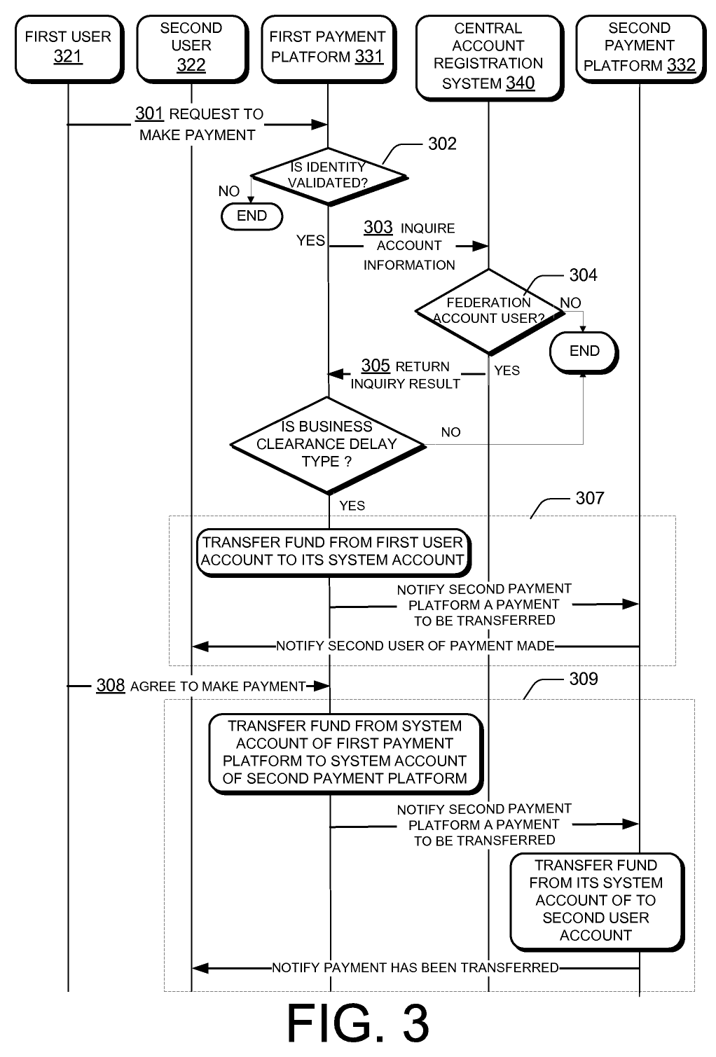

FIG. 3 shows a flowchart of an exemplary payment process in which the payer (buyer) initiates the payment process. With reference to FIG. 3, the specific steps used to complete the payment are described as follows:

Step 301: The first user 321 sends a request for making a payment to the first payment platform 331. The request includes the first user (321)'s identification, the second user (322)'s federation user ID and the amount of payment.

Step 302: After receiving the payment request, the first payment platform 331 uses the first user's identification to validate its identity. If the validation passes, the process proceeds to Step 303. Otherwise, the process ends.

Step 303: The first payment platform 331 sends an operation request (a payment request in the example illustrated) to the central account registration system 340. The request includes the information of the second user's federation user ID.

Step 304: After receiving the operation request, the central account registration system 340 determines if the second user 322 is a registered federation user according to the second user's federation user ID. If yes, the process continues to Step 305. Otherwise, the process ends.

Step 305: The central account registration system 340 uses the second user's federation user ID to inquire about the second user's federation user account and obtain the related information of the second payment platform 332, such as information of a system account of the second payment platform 332 and/or information of the platform user account corresponding to the federation user ID of the second user 322. The central account registration system 340 then sends this information to the first payment platform 331.

Step 306: The first payment platform 331 determines if the current business is of a delayed-clearance type. If yes, the process continues to Step 307. Otherwise, the first payment platform 331 may transfer the payment fund directly to the system account of the second payment platform 332, which then transfers the payment into the account of the second user account to end the process.

Step 307: The first payment platform 331 transfers the payment from the account of the first user 321 into the system account of the first payment platform 331 and notifies the second payment platform 332 that there is a pending payment to be transferred or cleared. The second payment platform 332 then notifies the second user 322 that the payment has been made.

Step 308: After the first user 321 and the second users 322 have agreed on the terms of transaction, the first user 321 may move to complete the payment by notifying the first payment platform 331 to transfer the fund.

Step 309: After receiving the notice from the first user 321, the first payment platform 331 uses the account information of the second payment platform 332 to complete the transfer. For example, the first payment platform 331 may transfer the payment from the system account of the first payment platform 331 to the system account of the second payment platform 332. The first payment platform 331 then informs the second payment platform 332, which in turn transfers the fund from its system account into the account of the second user 322.

On the other hand, if the first user 321 and the second user 322 cannot conclude the transaction, the first user 321 may send a request for revoking the payment to the first payment platform 331, which then sends a revocation request to the second payment platform 332. After the first payment platform 331 receives the authorization of cancellation from the second payment platform 332 and affirms the revocation, the first payment platform 331 transfers the payment back into the account of the first user and ends the process.

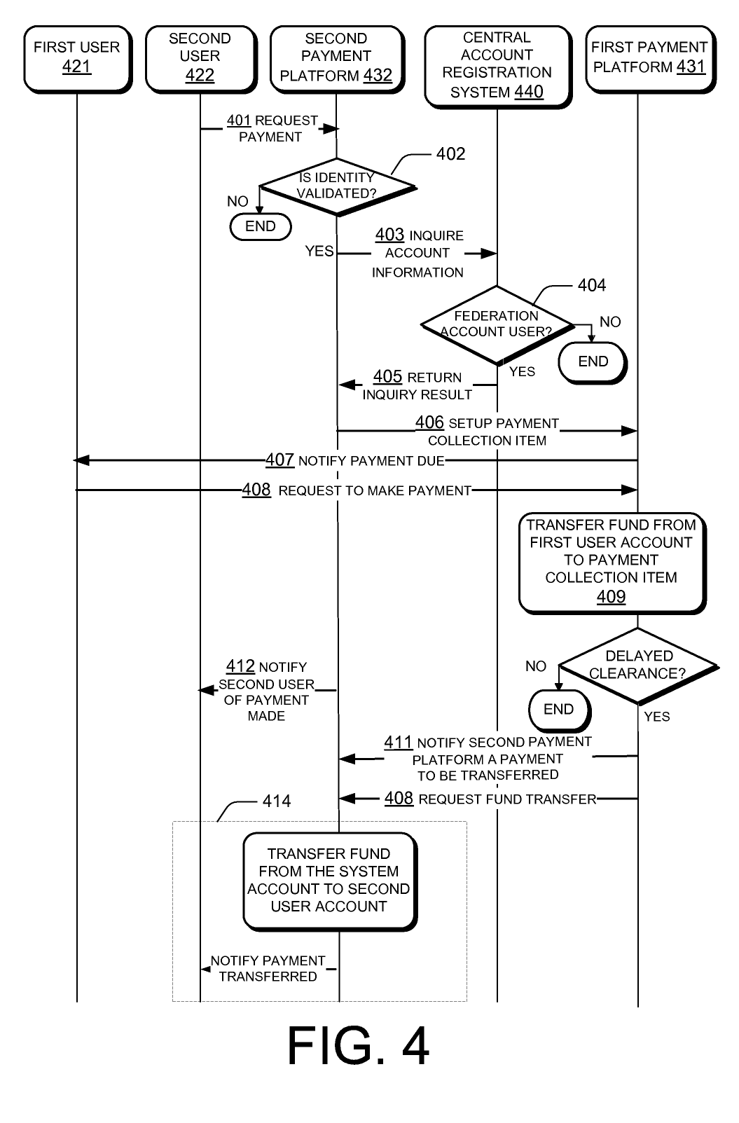

FIG. 4 shows a flowchart of an exemplary payment process in which the payee (seller) initiates the payment process. With reference to FIG. 4, the steps used to complete the payment are described as follows:

Step 401: The second user 422 sends a request for payment collection to the second payment platform 432. The request contains the information of the second user identification, the first user's federation user ID and the amount of payment.

Step 402: After receiving the collection request, the second payment platform 432 uses the second user identification to validate its identity. If validation passes, the process goes to Step 403. Otherwise, the process ends.

Step 403: The second payment platform 432 sends an operation request (a request for collecting a payment in the illustrated example) to the central account registration system 440. The request includes the information of the first user's federation user ID.

Step 404: After receiving the operation request, the central account registration system 440 determines if the first user 421 is a registered federation user according to its federation user ID. If so, the process continues to Step 405. Otherwise, the process ends.

Step 405: The central account registration system 440 uses the first user's federation user ID to inquire about its federation user account and obtain the related information of the first payment platform 431, such as the information of the first user's platform user account and/or the information of the system account of the first payment platform 431, corresponding to the first user's federation user ID. The central account registration system 440 then sends to the second payment platform 432 the information.

Step 406: After receiving the above information sent from the central account registration system 440, the second payment platform 432 notifies the first payment platform 431 to set up a payment collection item for the first user 421.

Step 407: After receiving the notice from the second payment platform 432, the first payment platform 431 creates a payment collection item and notifies the first user 421 to make the payment.

Step 408: After receiving the notice, the first user 421 sends a request for making a payment to the first payment platform 431.

Step 409: After receiving the request for making payment, the first payment platform 431 transfers the fund from the account of the first user into the payment collection item.

Step 410: The first payment platform 431 determines if the current business is of a delayed-clearance type. If so, the process continues to Step 411. Otherwise, the first payment platform 431 transfers the payment directly to the system account of the second payment platform 432, which transfers the payment into the account of the second user and ends the process.

Step 411: The first payment platform 431 notifies the second payment platform 432 that there is a pending payment to be transferred.

Step 412: The second payment platform 432 then notifies the second user 422 that the first user 421 has made the payment.

Step 413: After the first user 421 and the second user 422 have agreed on the terms of transaction, the first user 421 agrees to complete the payment and notifies the first payment platform 431 to transfer the fund.

Step 414: After receiving the notice from the first user 421, the first payment platform 431 completes the payment operation by transferring the payment from the payment collection item into the system account of the second payment platform, which in turn transfers the fund from its system account into the account of the second user.

Implementation Environment

The above-described payment system and method may be implemented with the help of a computing device, such as a server, a personal computer (PC) or a portable device having a computing unit.

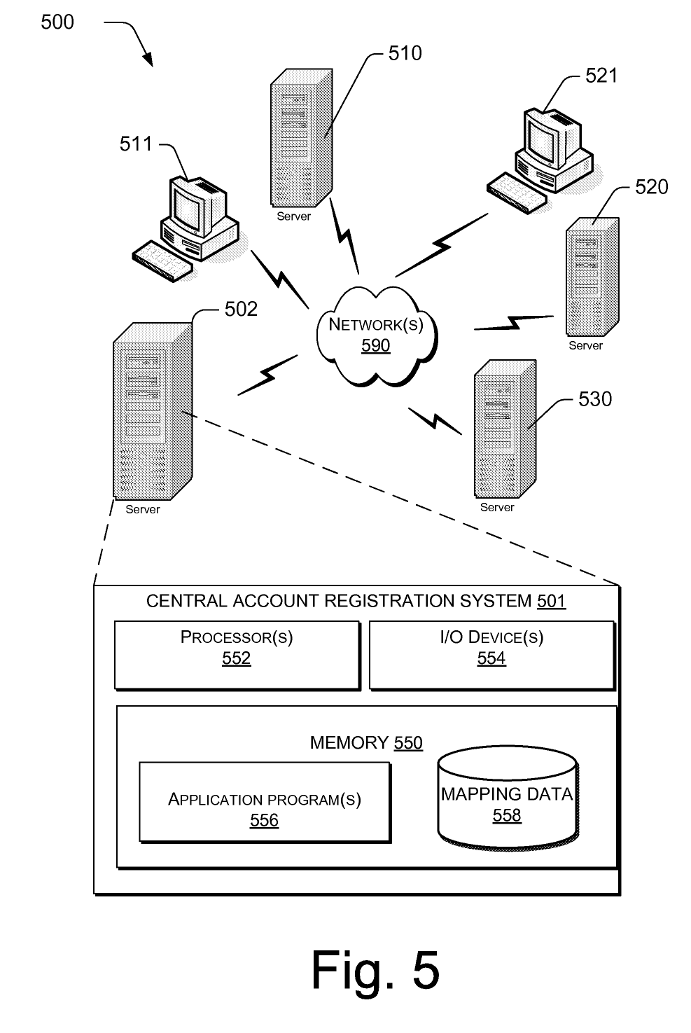

FIG. 5 shows an exemplary environment for implementing the payment system. The system 500 has a central account registration system 501 implemented in a computing device 502. The system 500 further includes payment platforms 510, 520 and 530, and user terminals 511 and 521, all connected through networks 590.

The central account registration system 501 implemented in the computer device 502 includes computer readable media (e.g., memory) 550, processor(s) 552, I/O devices 554 and network interface (not shown). The computer readable media 550 stores application program modules 556 and account mapping data 558.

Program modules 556 contains instructions which, when executed by a processor(s), cause the processor(s) to perform actions of a process described herein (e.g., the processes of FIGS. 3-4) to make a payment.

For example, in one embodiment, computer readable medium 550 has stored thereupon a plurality of instructions that, when executed by one or more processors 520, causes the processor(s) 552 to:

(a) receive from a first payment platform (e.g., 510) an operation request of a first user (e.g. 511), the operation request containing a second user's (e.g. 521) federation user ID;

(b) provide account information of a second payment platform (e.g., 520) to the first payment platform (510) according to the second user's federation ID included with the operation request; and

(c) make a payment according to the account information of the second payment platform 520.

It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. For example, a computer device may be, without limitation, a server, a PC, a game console, a set top box, and a computing unit built in another electronic device such as a television, a display, a printer or a digital camera.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A payment system implemented with a computing device having one or more processors and one or more I/O devices, the payment system comprising:
a central account registration system adopted for connecting a plurality of payment platforms to form an account federation in which each user has at least one federation user account and at least one platform user account, each federation user account being associated with a federation user ID,
wherein,
the central account registration system includes a computer readable media having stored thereupon account information and account mapping data defining account mapping relationships between the federation user accounts and the platform user accounts, wherein each federation user account corresponds to one or more platform user accounts;
the central account registration system is adapted for providing, upon receiving from a first platform an operation request of a first user, account information of a second payment platform to the first payment platform according to a second user's federation user ID included with the operation request of the first user; and
the payment system is adapted for making a payment according to the account information of the second payment platform.

2. The payment system as recited in claim 1, wherein the federation user IDs are assigned by the central account registration system.

3. The payment system as recited in claim 1, wherein the mapping relationships are such that each federation user account corresponds to no more than one platform user account on each payment platform.

4. A payment system comprising:
a plurality of payment platforms including a first platform and a second platform; and
a central account registration system connecting the plurality of payment platforms to form an account federation,
wherein the central account registration system is adapted for:
storing account mapping information between a federation user account and a platform user account,
assigning a federation user ID to each federation user account,
upon receiving from the first payment platform an operation request of a first user, providing account information of the second payment platform to the first payment platform according to a second user's federation user ID included with the operation request of the first user, and
making a payment according to the account information of the second payment platform.

5. The payment system as recited in claim 4, wherein the first payment platform is adapted for performing one or more of the following:
receiving the information of the second payment platform from the central account registration system;
transferring the payment from an account of the first user to a system account of the first payment platform, the account of the first user being either a platform user account or a separate user account; and
transferring the payment from the system account of the first payment platform to a system account of the second payment platform.

6. The payment system as recited in claim 5, wherein transferring the payment from the account of the first user to the system account of the first payment platform is performed only if current business is of a delayed clearance type; and transferring the payment from the system account of the first payment platform to the system account of the second payment platform is performed only if terms of transaction have been met.

7. The payment system as recited in claim 4, wherein the second payment platform is adapted for transferring the payment from a system account of the second payment platform to an account of the second user, the account of the second user being either a platform user account or a separate user account.

8. The payment system as recited in claim 4, wherein the second payment platform is adapted for notifying the second user receipt of the first user's payment after the payment has been transferred into an account of the second user, the account of the second user being either a platform user account or a separate user account.

9. The payment system as recited in claim 4, wherein the first payment platform is adapted for verifying an identity of the first user after receiving the operation request from the first user.

10. The payment system as recited in claim 4, wherein the first payment platform is adapted for transferring the payment from a system account of the first payment platform into an account of the first user if the first user and the second user are unable to conclude the transaction, the account of the first user being either a platform user account or a separate user account.

11. A payment system comprising:
a plurality of payment platforms including a first platform and a second platform; and
a central account registration system connecting the plurality of payment platforms to form an account federation,
wherein,
the central account registration system is adapted for storing account mapping information between a federation user account and a platform user account, assigning a federation user ID to each federation user account, and, upon receiving from the second payment platform an operation request of a second user containing a first user's federation user ID, providing account information of the first payment platform to the second payment platform according to the first user's federation user ID;
the second payment platform is adapted for instructing the first platform to set up a payment collection item according to the account information of the first payment platform; and
the first payment platform is adapted for setting up the payment collection item, receiving a payment from an account of the first user into the payment collection item, and transferring the payment from the payment collection item to the second payment platform.

12. The payment system as recited in claim 11, wherein the first payment platform is adapted for transferring the payment from the payment collection item to the second payment platform upon receiving a payment clearance permission from the first user, and wherein the second payment platform is adapted for transferring the received payment into an account of the second user, which is either a platform user account or a separate user account.

13. The payment system as recited in claim 11, wherein the first payment platform is adapted for transferring the payment from the payment collection item back to the account of the first user upon receiving a payment revocation request from the first user and/or a cancellation authorization from both the first payment platform and the second payment platform.

14. The payment system as recited in claim 11, wherein the second payment platform is adapted for notifying the second user, after the payment has been transferred into an account of the second user, that the payment has been cleared, wherein the account of the second user is either a platform user account or a separate user account.

15. A method of making payment, the method being used in a payment system containing a central account registration system for connecting a plurality of payment platforms to form an account federation, wherein each user has at least one federation user account and at least one platform user account, each federation user account is associated with a federation user ID, and each federation user account is mapped to one or more platform user accounts, the method of making payment comprising:
(a) receiving from a first payment platform an operation request of a first user, the operation request containing a second user's federation user ID;
(b) providing account information of a second payment platform to the first payment platform according to the second user's federation ID included with the operation request; and
(c) making a payment according to the account information of the second payment platform.

16. The payment system as recited in claim 15, wherein, when current business is of a delayed clearance type, the step (c) is completed only after terms of transaction have been satisfied.

17. The method of making payment as recited in claim 15, wherein the step (a) comprises:
(a1) receiving the operation request at the first payment platform from the first user; and
(a2) receiving the operation request at the central account registration system from the first payment platform.

18. The method of making payment as recited in claim 17, wherein the operation request further contains information of the first user's ID, the method further comprising:
verifying the first user's ID by the first payment platform before step (a2).

19. The method of making payment as recited in claim 15, wherein the payment is made from the first user to the second user, and the step (c) comprises:
(c1) transferring the payment from an account of the first user to a system account of the first payment platform, the account of the first user being either a platform user account or a separate user account;
(c2) transferring the payment from the system account of the first payment platform to a system account of the second payment platform according to the account information of the second payment platform provided to the first payment platform; and
(c3) transferring the payment from the system account of the second payment platform to an account of the second user, the account of the second user being either a platform user account or a separate user account.

20. The method of making payment as recited in claim 15, wherein the step (c) comprises:
(c1) transferring the payment from an account of the first user to a system account of the first payment platform, the account of the first user being either a platform user account or a separate user account; and
(c2) transferring the payment from the system account of the first payment platform back into the account of the first user if the first user and the second user are unable to conclude the transaction.

21. The method of making payment as recited in claim 15, wherein the payment is made from the second user to the first user, the step (c) comprises:
(c1) setting up a payment collection item at the second payment platform;
(c2) transferring a payment from the second user into a system account of the second payment platform according to the payment collection item; and
(c3) transferring the payment from the system account of the second payment platform to the first user if terms of transaction are satisfied, or transferring the payment from the system account of the second payment platform back to the second user if the terms of transaction are unsatisfied.

22. A method of making payment, the method being used in a payment system containing a central account registration system for connecting a plurality of payment platforms to form an account federation, wherein each user has at least one federation user account and at least one platform user account, each federation user account is associated with a federation user ID, and each federation user account is mapped to one or more platform user accounts, the method of making payment comprising:
(a) receiving from a second payment platform an operation request of a second user, the operation request containing a first user's federation user ID;
(b) providing account information of the first payment platform to the second payment platform according to the first user's federation ID provided with the operation request; and
(c) making a payment from the first user to the second user according to the account information of the first payment platform provided to the second payment platform.

23. The method of making payment as recited in claim 22, wherein the step (c) comprises:
(c1) setting up a payment collection item at the first payment platform;
(c2) transferring a payment from the first user into a system account of the first payment platform according to the payment collection item; and
(c3) transferring the payment from the system account of the first payment platform to the second user if terms of transaction are satisfied, or transferring the payment from the system account of the first payment platform back to the first user if the terms of transaction are unsatisfied.
